(19) United States
(12) Patent Application Publication
(10) Pub. No.: US 2014/0376592 A1
(43) Pub. Date: Dec. 25, 2014

(54) DEVICE FOR REPRESENTING AND DISPLAYING THE COIL TEMPERATURE OF AN ELECTRICAL POWER TRANSFORMER AND LIMITATION CIRCUIT SUITABLE THEREFOR

(71) Applicants: Sebastian Hollunder, Schmitten-Niederreifenberg (DE); Martin Kubiczek, Hofheim (DE)

(72) Inventors: Sebastian Hollunder, Schmitten-Niederreifenberg (DE); Martin Kubiczek, Hofheim (DE)

(21) Appl. No.: 14/123,925

(22) PCT Filed: May 25, 2012
(86) PCT No.: PCT/EP2012/059789

§ 371 Date: Feb. 19, 2014

(30) Foreign Application Priority Data
Jul. 14, 2011 (DE) 102011107375.6

(51) Int. Cl. G01K 13/00; G01K 1/02

(52) U.S. Cl. CPC G01K 13/00; G01K 1/02
USPC 374/152

(57) ABSTRACT

The invention relates to a device for representing and displaying the coil temperature of an electrical power transformer and to an electrical circuit suitable therefor. The invention is based on the general concept of using the CT-signal current not only for supplying the heating resistor of a sensor, for example, but also for decoupling energy from the CT-signal current by transformation via an electronic circuit according to the invention in order to supply energy to the connected measurement devices, so that a separate energy source can thus be ultimately omitted. According to the invention, the primary coil of a transformer, hereinafter referred to as removal transformer, is inserted into the CT-signal current and the voltage sloping via the primary coil and secondary coil of the removal transformer is limited in that a triac triggered by two diodes connected in parallel short-circuits as soon as the corresponding half-cycle reaches a threshold value and does not open again until the next current zero-crossing of the CT-signal current.

The present invention relates to an apparatus for representing and displaying the coil temperature of an electrical power transformer as well as a limiting circuit suitable for that purpose.

Transformers designed for high levels of power in electrical energy mains are termed power transformer. These power transformers are in that case subject in part to strong physical loads which are attributable to, for example, too-high load currents. These can be accompanied by excessive ageing phenomena within the power transformer and thus damage, which bring with them serious consequences for operational reliability. However, not only operational reliability, but also the service life of these expensive capital-cost items critically depend on operation of each individual power transformer in a manner which is as preserving as possible. One possibility for ensuring frictionless operation of a power transformer is to monitor the coil temperature of the power transformer.

In order to simulate and indicate the coil temperature of a power transformer a method has become known from, for example, DE 196 48 332 [U.S. Pat. No. 6,086,249] in which the measured and indicated temperature is formed from the temperature of the coolant for cooling the power transformer and the temperature of an electric heating means, which in turn is supplied with a current proportional to the load of the power transformer. For temperature measurement use is made of a thermometer which comprises a hollow measuring sensor, a mechanical measurement transducer, which is connected with the measuring sensor by a capillary tube, for actuation of a mechanical indicating device and a plurality of switches, wherein the interconnected cavities of the measuring sensor, capillary tube and measurement transducer form a closed pressure chamber filled with a measurement medium, the volume of which changes in dependence on temperature. The temperature of the coolant of the power transformer is directly measured with the help of the measuring sensor and through a direct heating, which is separate from measurement of the temperature of the coolant, of the measurement medium with the help of the electrical heating means immersed in the measurement medium an additional measurement pressure corresponding with the coil temperature of the power transformer is generated.

The electric heating means is arranged in an insulated heating chamber which is preferably connected by a capillary tube with the pressure chamber of measuring sensor and measurement transducer.

A further method, which is known from the prior art and which concerns indirect measurement of the coil temperature at power transformers, is known from DE 89 11 078 U1. In this method a hollow measuring sensor is arranged in an immersion sleeve for installation in a liquid-filled transformer casing and is surrounded by an insulating hose around which in turn is wound an electrical heating resistance, which for its part is encased by a further insulating hose. A current, termed CT signal current in the following, proportional to the load of the transformer is conducted, with the help of a power converter, via the heating resistance, the magnitude of which is so set to the heating resistance and the heat transfer in the direction of the measuring sensor and coolant that the temperature measured by the measuring sensor corresponds with the respective mean or maximum coil temperature of the power transformer.

The immersion sensor is in that case installed in the transformer casing in such a manner that the immersion sleeve is immersed in the cooling liquid of the transformer. In that case, the temperature difference between transformer coil and cooling liquid depends on the respective current in this coil. A current converter which detects the current, which is flowing across the transformer, as CT signal current is therefore associated with the transformer. The CT signal current of this current converter is now proportional to the current flowing across the transformer. the CT signal current subsequently flows via a heating resistance, which is associated with the temperature sensor, and thereby generates an indicating plot, which corresponds with the respective transformer load, relative to the actually measured oil temperature. As a consequence of a calibration undertaken before placing in operation it is possible in this indirect manner to obtain an indication of the mean or maximum coil temperature for a given current load of the power transformer, i.e. the display of display device, which is downstream of the heat temperature sensor, in a thermal image of the processes within the power transformer. The display can then take place, after appropriate amplification of the measurement signals, in a control room distant to a greater or lesser extent. It is alternatively also possible to electronically further process the relevant measurement values in a control and regulating installation, for example to form optical and/or acoustic warning signals. All these evaluating circuits of the CT signal current in that case, however, require a separate energy supply.

This form of simulation and indication of the coil temperature of an electrical power transformer has proved satisfactory in practice, but has the disadvantage that the evaluating circuits which measure, evaluate, analyze or indicate the current of a CT signal current circuit have to be supplied from a source, which is separate from the CT signal current, with the energy needed for their own requirements. For this purpose it is always necessary to install at least one further line, which conducts supply energy, additionally to the line of the CT signal circuit for power supply of the heating resistance as well as to provide a separate energy source. However, in the environment of devices conducting high voltage this means not only a substantial costs outlay, but also additional risks with respect to electromagnetic influencing of the supplied measuring device. This risk can in turn be remedied only with a substantial outlay in terms of safety technology.

It is therefore the object of the present invention to indicate an apparatus for representing and displaying the coil temperature of an electrical power transformer, which does not need an additional energy source for power supply of the measuring device for evaluation of the CT signal current.

This object is fulfilled by an apparatus for representing and displaying the coil temperature of an electrical power transformer with the features of the first claim. The subclaims in that case relate to particularly advantageous developments of the invention.

The present invention is in that case based on the general idea of using the CT signal current not only for supply of, for example, the heating resistance of a measuring sensor, but also to couple out the CT signal current energy by way of transformer via an electronic limiting circuit for power supply of the connected measuring device so that ultimately a separate energy source can thus be eliminated. For that purpose the primary winding of a transformer, termed tapping transformer in the following, is inserted into the CT signal current and limits the voltage, which decays by way of the primary winding and secondary winding of the tapping transformer, in that a triac, which is triggered by way of two diodes connected in parallel, short-circuits as soon as the corresponding half-wave of a threshold value is reached and opens again only with the next current zero transition of the CT signal current. Thus, in accordance with the invention additional lines or energy sources are no longer required for power supply of the evaluating circuit. The power supply of the connected evaluating circuit is, in addition, completely electrically separated from the CT signal current. The risk of entry of electromagnetic disturbances into the evaluating circuit is thus significantly reduced, which increases the reliability and service-life length of the components used and thus reduces costs.

The invention shall be explained in more detail in the following by way of example on the basis of figures, in which:

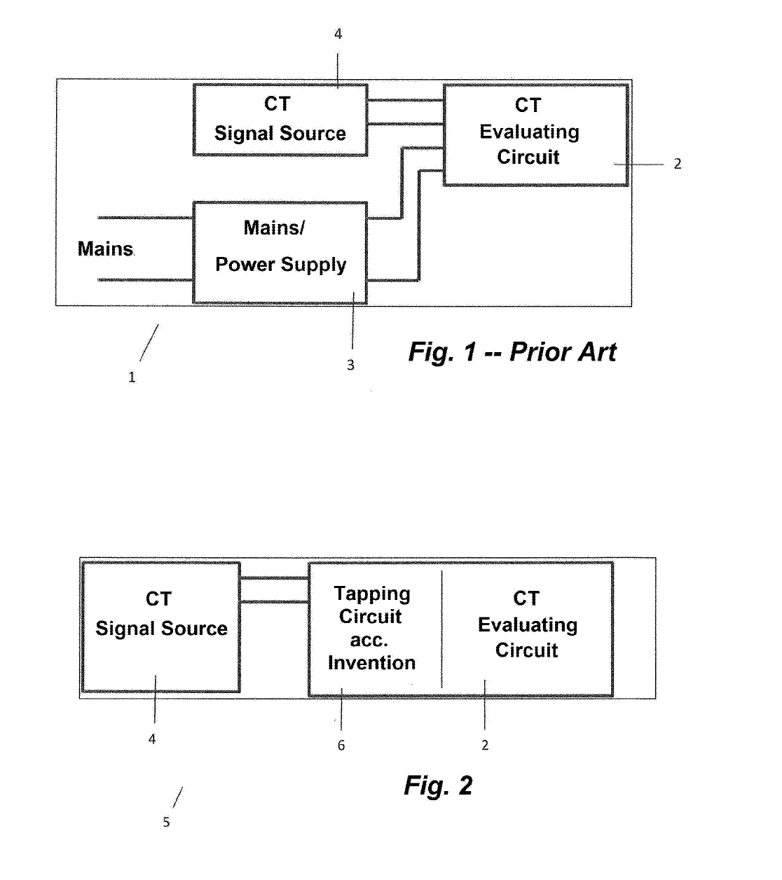

FIG. 1 shows an apparatus, which is known from the prior art, for simulating and indicating the coil temperature of an electrical power transformer, as described in DE 89 11 078 U1,

FIG. 2 shows an apparatus according to the invention for simulating and indicating the coil temperature of an electrical power transformer and

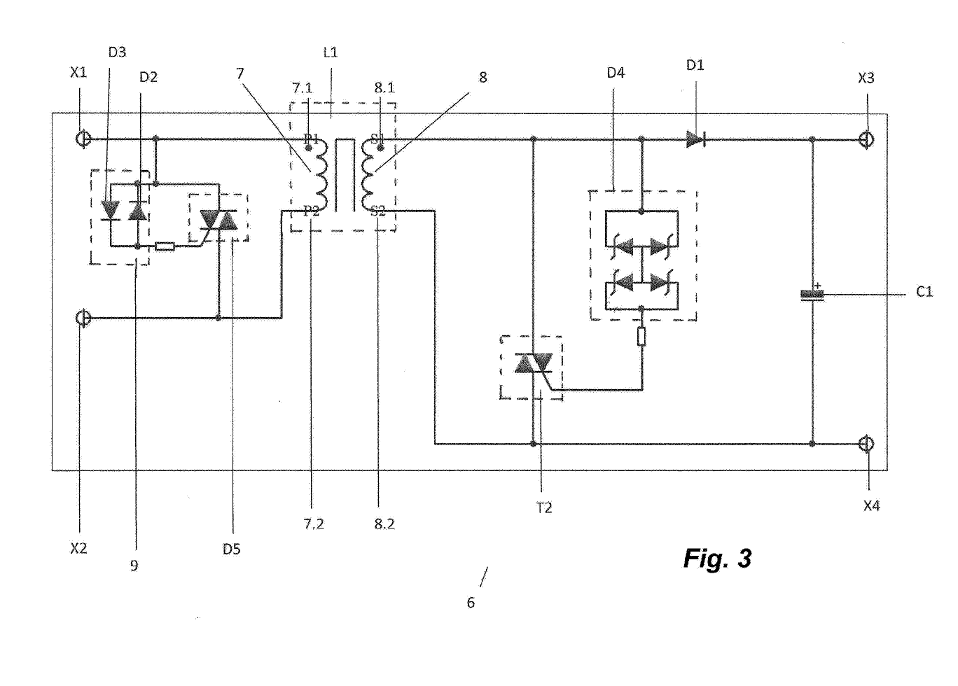

FIG. 3 shows a limiting circuit, particularly suitable for operation of the apparatus according to the invention.

FIG. 1 shows the schematic construction of an apparatus 1, which is known from the prior art and which needs a separate energy source 3 for power supply of a CT signal current evaluating circuit 2. An apparatus 1 of that kind has become known from, for example, DE 89 11 078 U1. The separate energy source 3 for power supply of the evaluating circuit 2 can be, for example, a mains power unit. In addition, the actual CT signal current used for the evaluation is tapped off, for example, in the form of a power converter, which then functions as a CT signal current source 4 for the evaluating circuit 2. The current converter associated with the transformer (not illustrated) detects the current, which is flowing across the transformer, as CT signal current. This CT signal current is proportional to the current flowing across the transformer. The CT signal current subsequently flows across the heating resistance of the measuring sensor which is associated with the temperature sensor and which ultimately indirectly indicates a display plot, which corresponds with the load of the transformer, of the actual oil temperature. In addition, the CT signal current tapped off by way of the current transformer is equally also used as a CT signal source 4 in order to illustrate, by means of the externally supplied evaluating circuit 2, the display course of the actual oil temperature.

FIG. 2 shows an apparatus 5 according to the invention, which for power supply of a CT signal current evaluating circuit 2 does not, like in FIG. 1, have to be supplied with energy by way of a separate energy source 3, but is supplied by means of an electrical limiting circuit 6, which is described in more detail in FIG. 3. The tapping-off of the CT signal current source 4 can also be carried out here by way of, for example, a current converter known from the prior art.

FIG. 3 shows the construction of the electrical limiting circuit 6, which on one side is connected by terminals X1 and X2 with the CT signal current source 4, whilst it is electrically connected on the other side by means of terminals X3 and X4 with the actual evaluating circuit 2. Moreover, a tapping transformer L1 with a primary side 7 and a secondary side 8 is provided. The primary side 7 in that case has connections 7.1 and 7.2, whereagainst connections 8.1 and 8.2 are provided on the secondary side 8. The tapping transformer L1 is, in the case of a rise in the current after the zero transition of the CT signal current, initially flowed through by current on the primary side 7 and transforms this current on its secondary side 8. The positive half-wave is fed by way of a diode D1, which is connected in series with the primary side 7, to a capacitor C1 and charges this in terms of energy. If the amount of the voltage between the connections 8.1 and 8.2 exceeds the value defined by a Z-diode arrangement D4 and the gate voltage of a bidirectional diode T2 then the secondary side 8 of the tapping transformer L1 is thereby short-circuited. The voltage drop across the primary side 7 thereby also drops to the amount determined by the resistive component of the primary impedance of the tapping transformer L1 as well as by the value of the CT signal current.

This has the consequence that the energy extraction in the case of the positive half-wave is limited to the energy flowing away in the charging of the capacitor C1. In the case of the negative half-wave, no energy is conducted into the downstream evaluating circuit 2 by way of the terminals X3 and X4, which if required can be subsequently optimized by use of a rectifier bridge. If in the case of a further rise of the instantaneous current in the course of the sine curve of the CT signal current through the resistive component of the primary side 7 of the tapping transformer L1 the voltage dropping across that now exceeds a specific value than the tapping transformer L1 is thereby short-circuited at its primary side 7. This voltage is determined by the breakdown voltage of two diodes D2 and D3, which are connected in anti-parallel arrangement and inserted into the gate path of the triac D5, as well as the gate voltage of a triac D5 electrically connected with the two diodes D2 and D3. In other words: the triac D5 short-circuits the primary side of the tapping transformer L1 exactly when the amount of the current through its gate has exceeded the trigger threshold. This is the case when the voltage between X1 and X2 in terms of amount exceeds the sum of the breakdown voltage of the diode D3 (positive half-wave) or D2 (negative half-wave) plus the gate threshold voltage of the triac D5.

1. An apparatus for representing and displaying the coil temperature of an electrical power transformer, wherein
a current converter is so arranged at a coil of the power transformer that this taps off the current, which is flowing across a coil of the power transformer, as a CT signal current,
the output of the current converter is so electrically connected with a heating element arranged within an oil-filled immersion sleeve that the heating element can be acted on by the CT signal current,
additionally arranged within the oil-filled immersion sleeve is a measuring sensor which is so electrically connected with an evaluating circuit constructed for displaying the measurement values that an image of the thermal heat relationships of the power transformer within the hermetically closed immersion sleeve can thereby be produced, which image can be displayed by means of the evaluating circuit, and
the energy supply of the evaluating circuit takes place by an electrical limiting circuit which is connected into the electrical connection of the power converter with the evaluating circuit and which equally taps off from the current converter the electrical energy required for the evaluating circuit.

2. The apparatus according to claim 1, wherein the electrical limiting circuit has terminals electrically connectable with the CT signal current source and terminals electrically connectable with the evaluating circuit, that the limiting circuit comprises a tapping transformer equipped with a primary side and a secondary side, wherein connections are provided on the primary side and connections are provided on the secondary side, that diodes in anti-parallel arrangement and a triac are electrically connected with the primary side of the tapping transformer and that a capacitor, a bidirectional diode and a Z-diode arrangement are electrically connected with the secondary side.
